(19) United States
(12) Patent Application Publication
(10) Pub. No.: US 2002/0082940 A1
(43) Pub. Date: Jun. 27, 2002

(54) System and method for developing a mart union to bring the regional stores into e-commerce

(75) Inventors: Xi-Nam Dam, Ottawa (CA); Brown Duan, Dalian (CN); Bob Bi, Dalian (CN)

Correspondence Address: DOUGHERTY & TROXELL, SUITE 1404, 5205 LEESBURG PIKE, FALLS CHURCH, VA, 22041, US

(73) Assignee: Global Mart Int'l (Dalian) Electronics Information Technology Co., Ltd.

(21) Appl. No.: 09/925,304

(22) Filed: Aug. 10, 2001

(30) Foreign Application Priority Data
Dec. 22, 2000 (TW) 89127755

(51) Int. Cl. G06F 17/60

(52) U.S. Cl. 705/26; 705/27

(57) ABSTRACT

A system and method that integrates all domains of stores into a mart union mounted in a web server coupled to the Internet is disclosed. The disclosed mart union encompasses a financial service unit, customer information table, purchase information table, and web pages employed for introduction of the union mart accompanied with electronic stores included inside. The electronic stores can be further classified based on business or professional characteristics so that traditional stores can employ or trust their electronic stores to advertise goods, commodities, and services they provided. Individuals can browse the web server mounted by the mart union to access information from web pages or electronic stores via communication links. Meanwhile, the browsing sequences or traces are simultaneously registered in the customer information table. Additionally, individuals can purchase goods or order services at electronic stores by putting all the ordered ones into virtual shopping carts provided by the mart union. Meanwhile, the information associated with all purchase transactions is simultaneously registered into the purchase information table. Payment services, such as accepting the amount of money of each purchase transaction and settling based on customers' authenticated accounts for the mart union are all forwarded to and then processed by the financial service unit. Information associated with the processed payment services is later routed to banks collaborating with the mart union for further manipulations. All the ordered goods or services are then offered and delivered by associated enterprises after settling accounts.

### BACKGROUND OF THE INVENTION

1. Field of the Invention

The present invention relates generally to a system and method for developing a mart union at a regional division or at any administrative division such as city. More specifically, the present invention relates to a system and method for developing a mart union to bring the regional stores into E-commerce. In a specific application, the present invention relates to a system and method that integrates regional mart unions to facilitate an individual when accessing information of all domains of stores from a regional division. The present invention generally reduces the efforts when an individual browses all domains of stores accompanied with goods or services they provided whatever the businesses or professions the stores are.

2. Description of the Prior Art

The global impact of electronic commerce has made goods and services available to individuals at an increasing exponential rate. With an increasing number of web servers mutually connected via various information exchange networks or communication links such as LANs, WANs, wireless communication networks, or the Internet, information exchange is more frequent and available than ever. This explosion in information accessibility encompasses all domains so that an individuals can browse information, e.g., sound recordings, restaurants, movies, hospitals, or clothing stores, by connecting their computer with desired web sites via a diverse range of information exchange networks.

Conventional businesses, such as a restaurant or clothing store, find it extremely difficult to maintain an Internet based web server in order to introduce goods or services to unspecified individuals or to transform their web site into a frequently visited one with revenues from advertising. An individual browsing via the Internet for information, particularly in a traditional domain, may encounter much difficulty. For example, searching for Chinese restaurants in a city on the Internet may not be representative of all Chinese restaurants since most of them may be unable to maintain web sites. Such a search may only lead to expensive restaurants that do not necessarily meet their preferences.

Nowadays, some businesses offer global or countrywide services via on-line shopping, for example, services such as book selling or some commodities that do not require the businesses to visit a customer's house. Such national or global businesses can offer goods or services goods that are more of luxury than a necessity for customers. An individual may purchase desired goods or commodities online by placing those items in virtual shopping carts provided by the web servers of these powerfully global or national businesses. Such orders made on-line can often be delivered to customers in a matter of days. However, for traditional businesses with less capital such as restaurants or movie houses, they can only serve a regional area in a very short interval or a limited division because they normally lack important resources such as effective shipment or payment systems for international or global enterprises. Nevertheless, customers of regional area traditional stores often become impatient with waiting for services from such a remote enterprise. Therefore, to facilitate trends in electronic commerce, a marketplace or a mart union must be developed for integrating traditional region wide businesses or enterprises that can not maintain Internet based web servers. Under such a scheme, individuals can access all domains of regional stores accompanied with goods or services merely by browsing the web server via the Internet. Individuals can browse a web server that integrates all regional mart unions to access information of all domains of stores from a specific regional division.

### SUMMARY OF THE INVENTION

The principal object of the present invention is to provide a system and method which introduces the traditional enterprises in a regional division, such as a county, a province, or any administrative division, into electric commerce by integrating electrical stores of themselves into a mart union mounted in communication links.

The other object of the invention is to provide a system and a method for introducing a mart union, which integrates all domains of enterprises in a regional division by classifying their electrical stores according to business or profession characteristics that any individual may order goods or services by accessing or browsing the electrical stores.

The further object of the invention is to provide a system and method for developing a mart union service center that integrates regional mart unions to facilitate an individual to survey all the integrated regional mart unions by browsing the web servers belonged to the regional mart unions or the mart union service center.

In one embodiment, a mart union basically encompasses a financial service unit, a customer information table, a purchase information table, and web pages employed for introductions of the union mart accompanied with electrical stores included inside. The electrical stores may be further classified based on business or profession characteristics so that traditional stores may employ or trust their electrical stores to advertise goods, commodities, and services they provided. An individual may browse the web server mounted by the mart union to access information from web pages or electrical stores via communication links, while the browsing sequences or traces are simultaneously registered in the customer information table. Meanwhile, an individual may purchase goods or order services at the electrical stores by placing all the ordered ones into virtual shopping carts provided by the mart union, while the information associated with all purchase transactions are simultaneously registered into the purchase information table. Payment services, such as accepting the amount of money of each purchase transaction and authenticated accounts for the mart union are all forwarded to and then processed by the financial service unit. Information associated with the processed payment services is later routed to banks collaborate with the mart union for further manipulations, e.g., notifying the customer to pay money for the purchase goods before a given deadline. All the ordered goods or services are then offered and delivered by associated enterprises after settling accounts.

In the embodiment, a web server mounting the aforementioned mart union couples with banks and enterprises that participate in the mart union via communication links such as LANs, WANs, wireless communication networks, or the Internet, while an individual may browse the mart union for accessing various information. The web server including an order management module, stock management module, and sales management module is regarded as a back end that the program codes provided in the modules are performed in the processor or processors of the web server to complete associated operations of the union mart. All the web pages provided by the web server are regarded as a front end for introducing an individual for browsing the web server via the communication links. Any computer-readable storage medium, e.g., a hard disk, floppy disk, magnetic optical disk, or non-volatile memory such as flash memory may be employed to stores the program codes of the aforementioned modules. Order management module basically encompasses an order tracking module, a settled tracking module, a shipment tracking module, and a customer response management module that all store program codes for order management. Stock management module basically encompasses a goods category management module, a stock-in management module, a stock-out management module, and a supplier management module that all store program codes for stock management of the electrical stores. Sales management module basically encompasses an urgent selling management module and a transaction flow management module both including program codes provided for sales management.

In another embodiment, the mart union may integrate all domains of stores of a regional division into electrical stores together so that an individual may access the store information by browsing the web server of the mart union whatever businesses or professions the stores are. All the enterprises or service providers may devote their efforts to their own businesses, such as delivering the ordered goods to the customer within the given deadline, instead of maintaining or handling the electrical stores only by trusting their own electrical stores to the mart union.

In a still further embodiment, a mart union service center that integrates all the regional mart unions together to facilitate any individual to access the information provided by the regional mart unions accompanied with the electrical stored included inside by browsing associated web servers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of the mart union of the embodiment;

FIG. 2 is a detailed schematic diagram of an electrical store in FIG. 1 of the embodiment;

FIG. 3 is a flowchart showing the overall sequences when an individual accesses and then purchases goods or orders services in the preferred embodiment;

FIG. 4A is a schematic diagram illustrative of the module configuration of the order management module according to the present invention;

FIG. 4B is a schematic diagram illustrative of the module configuration of the stock management module according to the present invention;

FIG. 4C is a schematic diagram illustrative of the module configuration of the sales management module according to the present invention;

FIG. 5A is an exemplary page configuration of the mart union mounted by using the approach disclosed in the embodiment;

FIG. 5B is an exemplary home page of FIG. 5A; and

FIG. 6 is an exemplary diagram when a customer orders a meal from an electrical store of a restaurant in the mart union according to the invention.

### DESCRIPTION OF THE PREFERRED EMBODIMENT

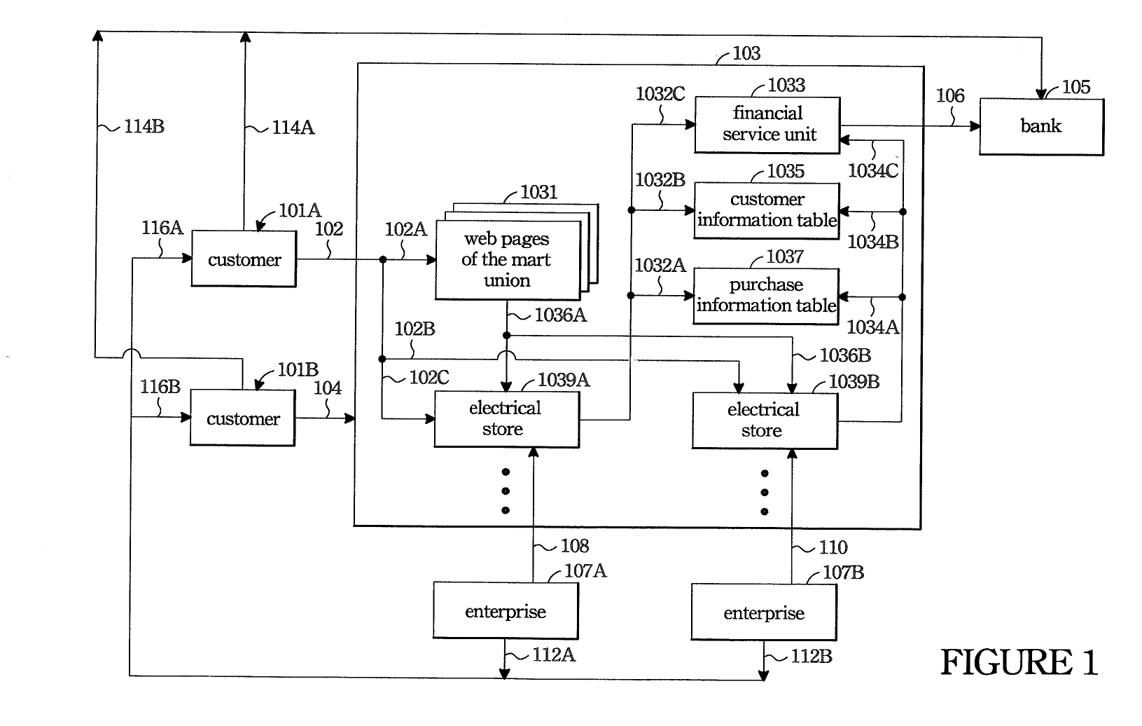

FIG. 1 schematically depicts mart union 103 of the embodiment. In mart union of FIG. 1, a web server mounting mart union 103 is developed to couple to a bank 105, a plurality of enterprises (or service providers) such as 107A and 107B which participate in the mart union of the embodiment over communication links for exchanging information. Mart union 103 further encompasses web pages 1031, a financial service unit 1033, a customer information table 1035, a purchase information table 1037, and a plurality of electrical stores such as 1039A and 1039B. Web pages 1031 invite customers 101A and 101B to visit disclosed mart union 103 that shows associated frames to give entrances for further introducing all electrical stores 1039A and 1039B. Financial service unit 1033 receives and manipulates payment service requests 1032C and 1034C associated with purchase transactions such as the amount of money involved in transactions or customers' authenticated accounts for settling from electrical stores 1039A and 1039B, respectively. Information 106 associated with the processed payment services is later routed to bank 105 collaborating with the mart union for further manipulations, e.g., notifying the customer to pay for the purchase goods before a given deadline. Customer information table 1035 receives and records personal information or browsing sequences such as names, identifications, or authenticated or approved accounts, and browsing traces, from customers 101A or 101B. Purchase information table 1037 stores information of every purchase transaction, such as the amount of money, names or titles, amount of goods, and ways of shipment for each purchase transaction. Of course, skilled persons can employ an individual table (not shown) to store the personal information instead of storing in the customer information table mentioned above. However, the appended claims should include all of the similar arrangements within the spirit of the embodiment.

Each electrical store 1039A or 1039B of the mart union of the embodiment, respectively, couples to the financial service unit 1033, customer information table 1035, and purchasing information table 1037 to forward related information for registry. For example, electrical store 1039A, respectively, forwards customers' purchase information 1032A, browses sequences or personal information 1032B related with customers which browses electrical store 1039A, and payment service requests 1032C associated with each purchase transaction to the relative unit or tables aforementioned. Similarly, store 1039B couples to the financial service unit 1033, customer information table 1035, and purchasing information table 1037 by forwarding customers' purchasing message 1034A, customers' messages or information 1034B, and payment service requests 1034C thereto, respectively.

Customers 101A and 101B in client terminals can access the web server, respectively, via communication links 102 and 104. Meanwhile, enterprises 107A and 107B receive orders and give management commands to manage their own electrical stores 1039A and 1039B, respectively, via communication links 108 and 110. Customers 101A and 101B can browse either web pages 1031 or electrical stores 1039A or 1039B, respectively, by browsing through 102A, 102B, and 102C across the communication link 102. However, customer 101A or 101B can browse the web pages of electrical stores 1039A or 1039B by redirecting 1036A or 1036B from web pages 1031. After completing purchase transactions, customer 101A or 101B can pay money 114A or 114B to bank 105. Meanwhile, he or she can receive the ordered goods, commodities, or services 116A or 116B delivered from enterprises 107A or 107B (respectively from 112A or 112B).

The web server, including and manipulating all operations of mart union 103, is regarded as a back end. Meanwhile, all the web pages provided by the web server are regarded as a front end for introducing customers 101A and 101B for browsing the web server via associated communication links. Conventional client/server or multi-tiers configurations can be employed in the embodiment for transferring information between customer 101A (101B) and the web server. However, the data-binding technology can be employed to further facilitate querying or browsing performance.

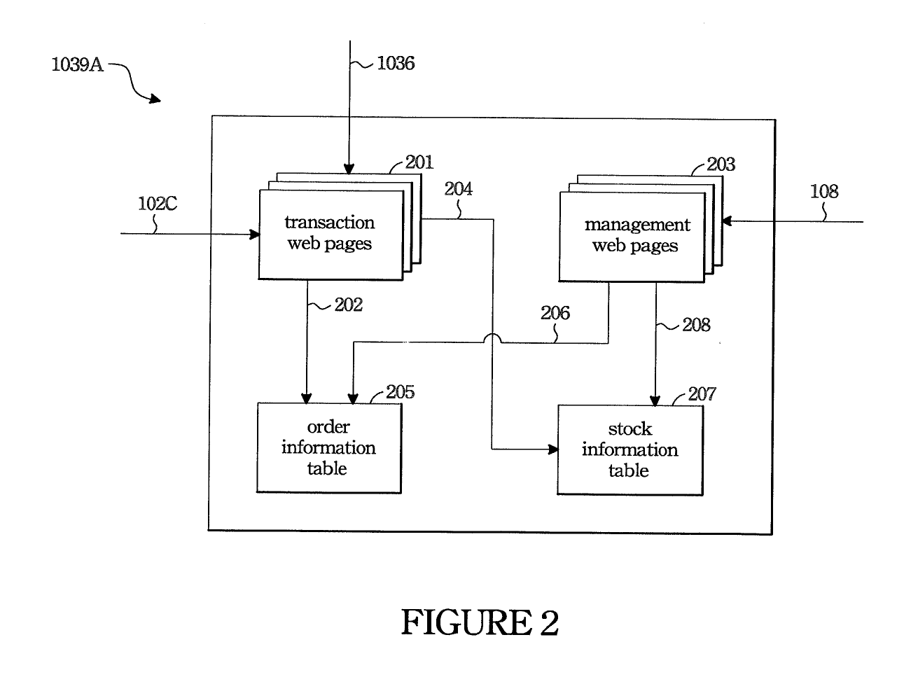

FIG. 2 schematically depicts electric store 1039A of FIG. 1. However, each electrical store of the embodiment has the same configuration as that of electrical store 1039A. Electrical store 1039A encompasses transaction web pages 201, management web pages 203, order information table 205, and stock information table 207. Similar to mart union 103, electrical store 1039A offers transaction web pages 201 for introducing the services or goods provided by the owner of the electrical store 1039A (i.e., enterprise 107A). Customer 101A can thus browse 102C web pages 201 and order desire goods or services as his or her wishes by placing the ordered ones into virtual shopping carts provided by mart union 103. When an order is made, order information 202 (including the titles), amounts of the ordered goods or services, deadline of delivering ordered goods or services, and addresses for accepting ordered goods or services is transferred to register in the order information table 205. Stock information of all goods or commodity also appears on web pages 201 by a browsing flow 204 in the purchase transaction. Enterprises 107A manages its electrical store 1039A to receive an order accompanied with detailed contents by browsing management web pages 203 via communication link 108. Order and stock information can also be accessed, respectively, by browsing 206 and 208 for order information table 205 and stock information table 207, respectively. Notably, all conventional database systems such as relational databases (SQL, Sybase, or Oracle) or object-oriented DBMS can be employed to develop databases for storing the above-mentioned tables in FIGS. 1 and 2.

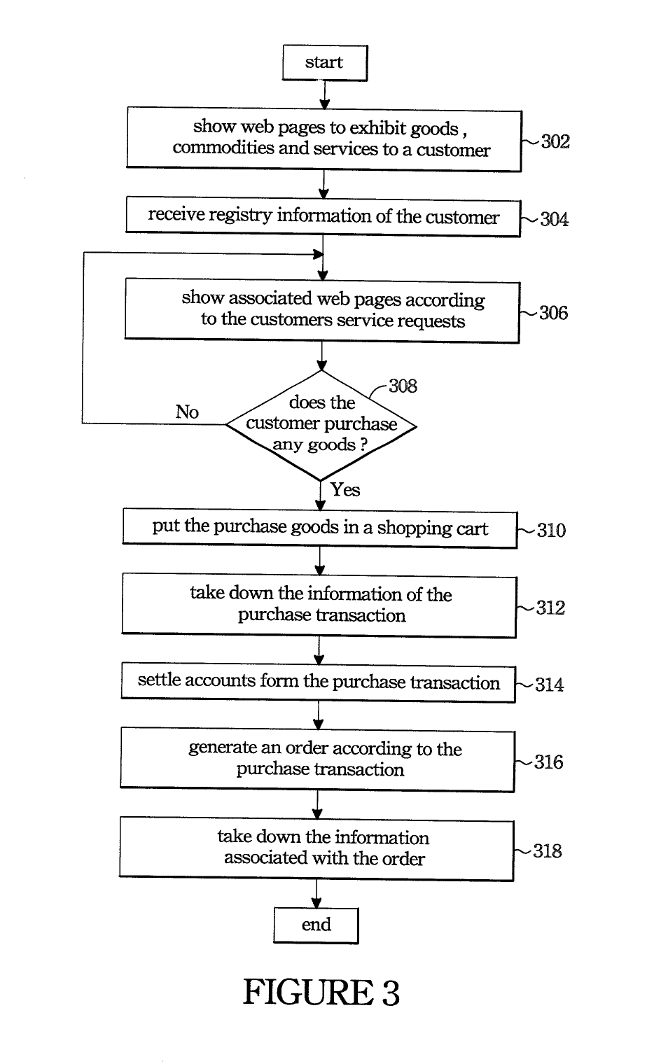

FIG. 3 illustrates the overall sequences when a customer browses to purchase goods or services in union mart 103 of the embodiment. Web pages 1031 are shown to exhibit the categories of goods, commodities, or services of mart union 103 in block 302 after the customer accesses web server 103. Registry information, including identification and password (or identifier) of the customer, is then transferred to mart union 103 in block 304. Therefore, the customer can browse mart union 103 and electrical stores 1039A and 1039B via associated communication links in block 306. When the customer purchases a product or service in mart union 103, those purchased goods, commodities, or services are placed in the virtual shopping cart via blocks 308 to 310. Information of the purchase transaction is then respectively taken down into the customer information table 1035 and purchase information table 1037 in block 312. Payment information such as the amount of money based on the purchase transaction is manipulated in financial service unit 1033 by settling accounts provided and authenticated by the customer in block 314. Mart union 103 derives the order associated with the purchase transaction in block 316. Meanwhile, the order information is taken down in the order information table 205 and stock information table 207 in block 318. Notably, the above customer identifiers can be employed optionally, and any ordinary person who are skilled in the art of the invention can modify the disclosed approaches as various applications.

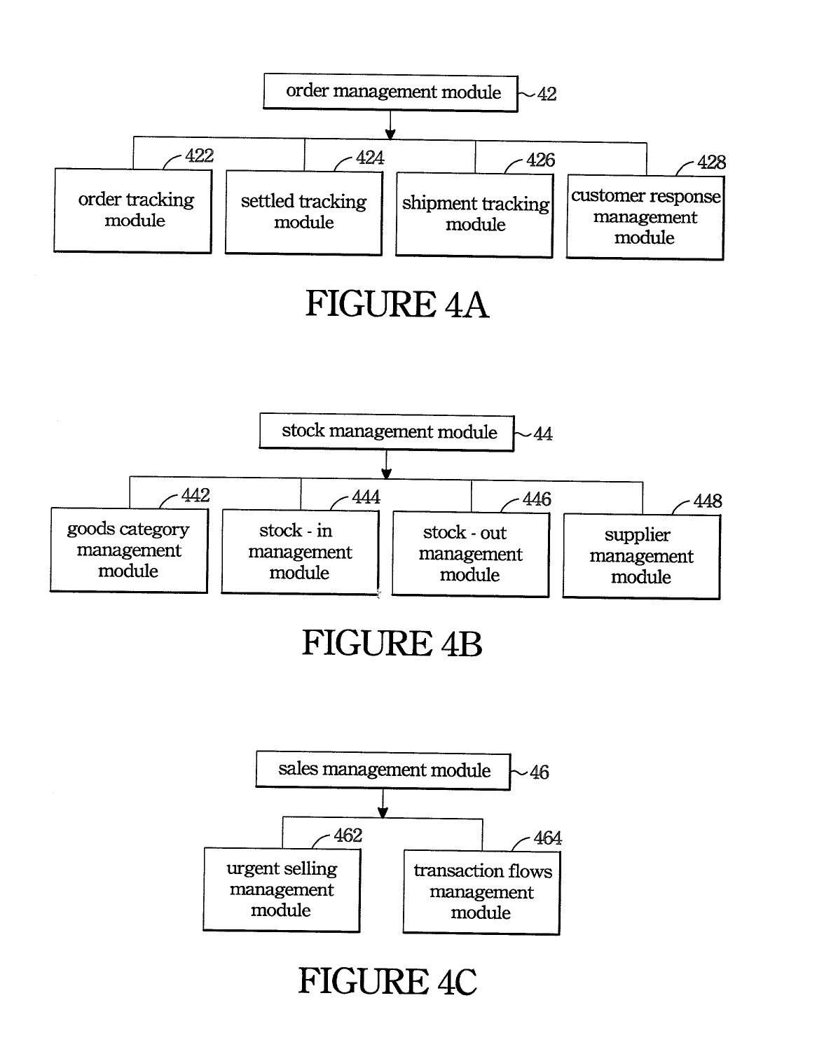

Above mentioned Web pages are regarded as front ends, or the Internet user interfaces, provided for browsing purposes. While the web server implements the program codes provided by an order management module 42, stock management module 44, and sales management module 46 are, respectively, depicted in FIGS. 4A to 4C to become a back end in the embodiment. For example, web pages 1031 receive an order of a purchase transaction from customers and forward relative information to tables 1035, 1037, 205, 207. Meanwhile, processors of the web server implement the program codes of modules 42, 44, 46 to perform operations for each purchase transaction. Obviously, a finance service module can be used to store program codes operated by the processor or processors of the web server to perform all the operations of financial service unit 1033 aforementioned. Notably, all processor types such as CPUs or microprocessors mounted in modern computer systems can be used in the embodiment to operate the program codes. However, the program codes can be stored in a storage medium readable by any computer host, e.g., hard disks, floppy disks, magnetic optical disks, or non-volatile memories such as flash memories. Any person skilled in the art of the present invention can employ a computer-readable storage medium as applications. However, all the similar arrangements and modifications within the spirits of the embodiment should be included in the scope of the appended claims.

The order management module 42 in FIG. 4A encompasses an order tracking module 422, settled tracking module 424, shipment tracking module 426, and customer response management module 428 that provides program codes for order management. The order tracking module 422 stores the program codes provided for the processor or processors of the web server to execute the operations of taking orders from customers and determining whether the ordered goods or services have been delivered to the customers. Settled tracking module 424 stores the program codes provided for the processor or processors of the web server to execute the operations of settling accounts for purchase transactions according to the accounts authenticated by customers and manipulating the account change procedures for customers. Shipment tracking module 426 stores the program codes for the processor or processors of the web server to execute the operations of monitoring the status of delivering the services or goods ordered by customers, and recording all the suppliers that provide systems for delivering the services or goods. Customer response management module 428 stores the program codes provided for the processor or processors of the web server to execute the operations of receiving positive or negative responses from customers, and redirecting those responses to relative enterprises.

The stock management module 44 in FIG. 4B contains a goods category management module 442, stock-in management module 444, stock-out management module 446, and supplier management module 448 that provides program codes for stock management. Goods category management module 442 stores the program codes for the processor or processors of the web server to implement the operations of accessing and displaying goods categories to customers as well as manipulate the modifications to goods or service categories. Stock-in management module 444 stores the program codes for the processor or processors of the web server to execute the operations of modifying the amount when goods are laid in stocks and notification is made of how many reserves are in the stocks. Stock-out management module 446 stores the program codes for the processor or processors of the web server to execute the operations of modifying the amount when goods being taken out from stocks and notifying how many reserves in the stocks. The supplier management module 448 stores the program codes for the processor or processors of the web server to execute the operations of managing the information concerned with suppliers, for example, the names or bases of those express delivery or shipping companies collaborating with mart union 103.

Sales management module 46 in FIG. 4C consists of an urgent selling management module 462 and a transaction flow management module 464, which provides program codes for sales management. Urgent selling management module 462 stores the program codes for the processor or processors of a web server to effectively manage an urgent selling (e.g., clearance sale), which includes goods, intervals, special discounts, profit controls, or presents given if a transaction involves for urgent selling. Transaction flow management module 464 stores the program codes for the processor or processors of the web server to execute the operation of assigning the ways or procedures for all purchase transactions. Consider the example of the payment ways for settling accounts for all transactions including the urgency of selling, the shipment ways for delivering the ordered goods. One of the express delivery companies for delivering goods is designed by executing the program codes.

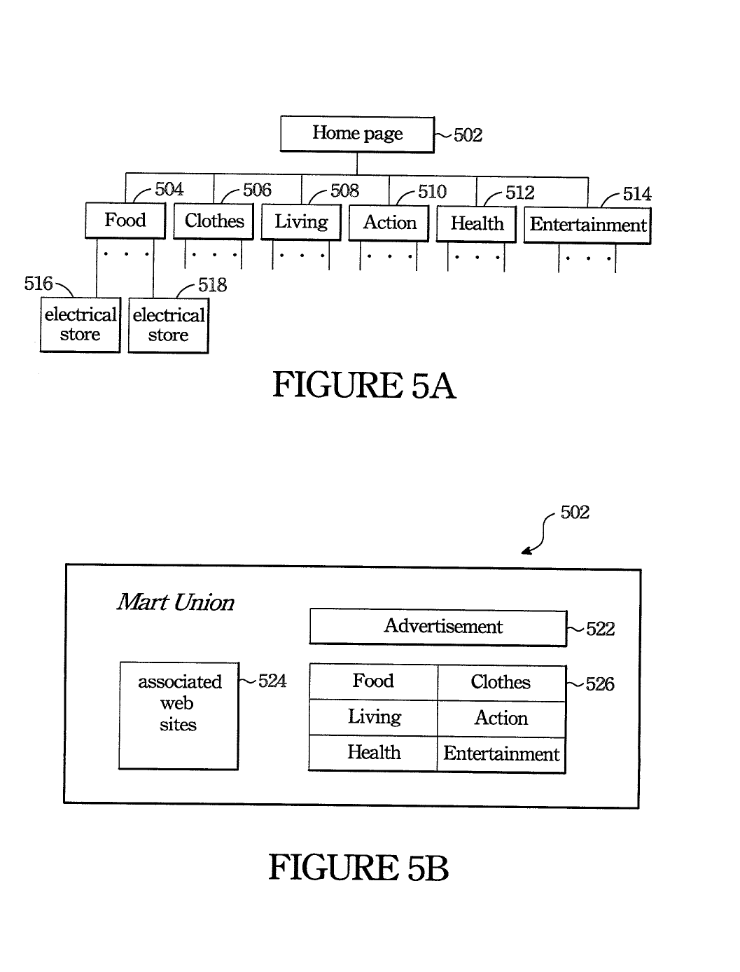

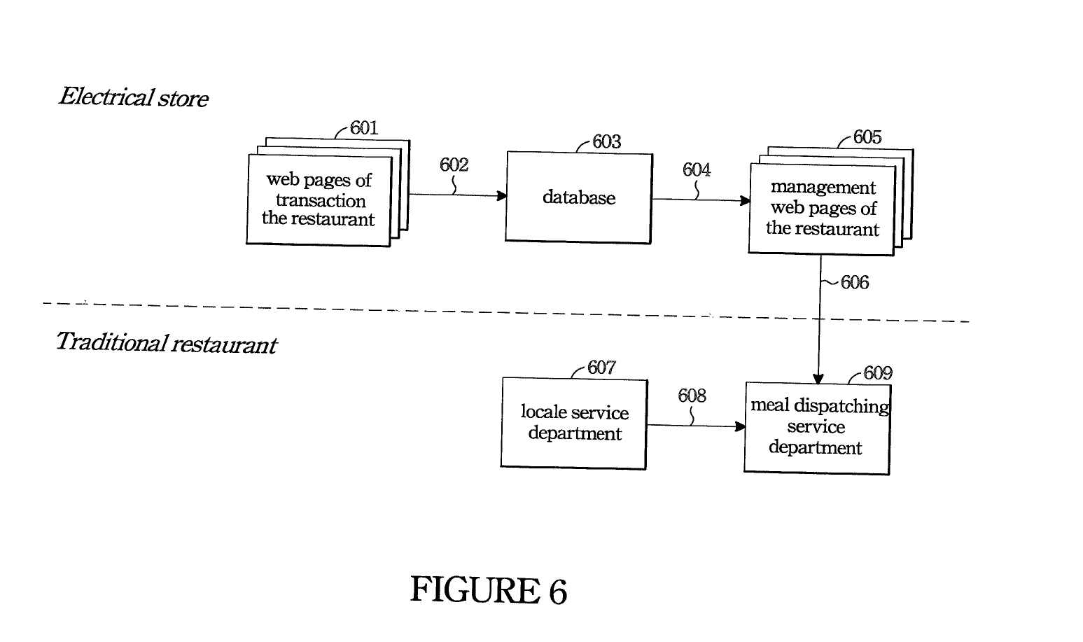

FIG. 5A depicts an exemplary web page configuration of mart union 103 in the embodiment, while FIG. 5B depicts an exemplary home page in FIG. 5A. Mart union 103 includes electrical stores that are further classified according to eating, clothing, housing, transportation, health, and amusement information they provided. An exemplary home page 502 in FIG. 5B displays a plurality of frames 522, 524, and 526 to provide entrances for browsing each first-level web page. For example, frame 526 provides entrances to browse first-level web pages 504, 506, 508, 510, 512, and 514, while the other two frames 522 and 524, respectively, provide entrances for browsing advertisements and associated web sites. A customer may browse electrical stores of mart union 103 via the above-mentioned entrances for accessing information or purchasing goods or services. For example, electronic stores 516 and 518 providing foods can be browsed after the customer accesses “Eating” from frame 526. Purchase transactions of ordering foods can be achieved by following the flow chart of FIG. 3. FIG. 6 provides a further detailed exemplary flow for ordering foods. Assume that a customer browses web pages 601 (e.g., web pages 1031 or 201) in the electronic store (e.g., 1039A) of a traditional restaurant and to give an order 602 registering in a database 603 of a restaurant. A meal dispatching service department 609 of the restaurant accepts order 604 by browsing the management web pages 605 via communication link 606 (e.g., communication link 108). Means of shipment for delivering the ordered foods to the customer are determined in meal dispatching service department 609 based on the information registered in the order 604. Obviously, a locale service department 607 conventionally provided is used to receive food orders for those customers who come in person to the restaurant. Delivery approaches of these food orders are also dealt with in meal dispatching service department 609.

Although a traditional store can manage its own electrical store in the mart union 103, the union mart may control all administrative affairs of the electronic stores, such as updating contents of the web pages 201, settling accounts for purchase transactions, or managing customer or purchase information. An enterprise can trust its electronic store to mart union 103 in the embodiment, thus allowing a traditional enterprise to focus on its enterprise. Meanwhile, mart union 103 can devote its efforts to motivate the public to pay more attention on its activities. Obviously, any customer who wants to conduct a purchase transaction can redirect the web server mounted by the enterprise from the electronic store if deemed necessary. Therefore, the enterprise should be totally responsible for all of its transaction behaviors, including negotiating, contracting, and determining means of payment and shipment. On the other hand, mart union 103 can provide different platforms deemed appropriate for different domains of businesses or professions to facilitate browsing performances. Additionally, mart union 103 may be developed to integrate all stores regardless of whether it is fashionable or traditional in a regional division such as a city, county, or even administrative division. Actually, a mart union service center integrates all regional mart unions mentioned above for browsing according to people of a nation, country, or worldwide. Moreover, service information can be easily accessed from electronic stores merely by browsing the web server of the mart union service center mounted in the Internet.

The present invention has the following merits. First, all regional enterprises regardless of whether they are traditional, general or fashionable enterprises can be integrated into the disclosed mart union by further classifying their electronic stores based on business or professional characteristics. Individuals can browse the web server mounting the mart union via an associated communication link to access information including goods, commodities, or services provided by the regional enterprises from electronic stores. Purchase transactions can be conducted in electronic stores so that individuals can obtain the ordered goods or services delivered from enterprises. Second, regional enterprises which are less effective in maintaining or handling web servers in the Internet to introduce or advertise those goods or services they provided may join the mart union and trust their electronic stores to the mart union. All the less-powerful enterprises can focus on their enterprises, while the mart union should attempt to transform itself into a well-known one via various advertisements or other avenues. Another merit is that a mart union service center that integrates all regional mart unions in a regional division, e.g., a city, province, county, or any administrative division, can be mounted in a web server to allow any unspecified individual for accessing national, or even worldwide enterprise information.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A mart union including stores of a regional division, said mart union comprising:
a plurality of electrical stores for introducing goods or services provided by enterprises that own said electrical stores, each of said electrical stores being belonged to one of said enterprises and said plurality of enterprises coupling with said mart union for managing said electrical stores;
a customer information table coupled with said electrical stores for registering browsing sequences of a customer who browsing said mart union;
a purchase information table coupled with said electrical stores for registering purchase information of a customer who purchases goods or services in said mart union;
a financial service unit coupled with said electrical stores for receiving payment service requests caused by purchase transactions from said electrical stores; and
mart union web pages for introducing said mart union and said electrical stores included in said mart union, at least one of said mart union web pages redirecting said customer to browse said electrical stores.

2. The mart union according to claim 1, each one of said electrical stores comprising:
transaction web pages for introducing said goods or services provided by said enterprises who own said electrical stores;
management web pages browsed by said enterprises for managing said electrical stores;
order information table coupled with said transaction web pages for receiving order information associated with a purchase transaction, and coupled with said management web pages for offering said order information; and
stock information table coupled with said transaction web pages for offering stock information of said electrical stores, and coupled with said management web pages for offering said stock information.

3. The mart union according to claim 2, said electrical stores being classified into business or profession characteristics, a redirection from said union mart web pages to one of said electrical stores following said classifications of said business or profession characteristics.

4. The mart union according to claim 2, said order information comprising said customer' name, amounts of said ordered goods or services, a deadline of delivering said ordered goods or services, and addresses for accepting said ordered goods or services.

5. The mart union according to claim 1, said customer information table receiving and taking down information comprising names, identifications, or authenticated accounts of said customer.

6. The mart union according to claim 1, said purchase information table storing information comprising an amount of money, titles of goods or services, or an amount of goods for each of said purchase transactions.

7. The mart union according to claim 1, said payment service requests comprising an amount of money concerned with transactions or authenticated accounts of said customer for settling.

8. The mart union according to claim 1 further comprising an mart union service center that integrates a plurality of said mart unions that each mart union is mounted in a regional division, said customer who browses said mart union service center may be redirected to one of said integrated regional mart unions.

9. A method for dealing with a purchase transaction in a mart union including electrical stores of a regional division, said method comprising the steps of:
showing mart union web pages for exhibiting goods or services of said electrical stores included in said mart union;
generating a purchase transaction by a customer via browsing said mart union web pages;
registering purchase information of said purchase transaction in said mart union;
generating an order associated with said purchase transaction by said mart union; and
delivering a goods or service indicated by said purchase transaction from an enterprise who owns said electrical store that dealing with said purchase transaction.

10. The method according to claim 9, each one of said electrical stores being belonged to an enterprise that manages said electrical store via management web pages of said electrical stores.

11. The method according to claim 9, said electrical stores being classified into business or profession characteristics, a redirection from said union mart web pages to one of said electrical stores following said classifications of said business or profession characteristics.

12. The method according to claim 9, at lease one sequence for generating said purchase information being registered in said mart union.

13. The method according to claim 9, further comprising a step of settling accounts according to an account authenticated by said customer in said mart union being performed before said delivering step.

14. The method according to claim 9, further comprising a step of redirecting to one of said electrical store from said mart union web pages.

15. The method according to claim 9, further comprising a method for constituting an mart union service center that integrates a plurality of mart unions mounted in regional divisions, said customer who browses said mart union service center may be redirected to one of said integrated regional mart unions.

16. A server system for mounting a mart union that integrates electrical stores of regional enterprises, goods or services provided by said regional enterprises being exhibited via mart union web pages of said mart union, said server system comprising:
a storage device; and
at least one processor, said processor operating program codes stored in said storage device to
exhibit web pages for introducing said mart union and goods or services provided by said electrical stores;
redirect a customer to one of said electrical store;
manage an order of a purchase transaction for said electrical stores;
manage stocks for said electrical stores;
manage sales flow for said electrical stores; and
manage payment services for said electrical stores.

17. The server system according to claim 16, said processor operating said program codes for managing said order to
perform operations of taking down said order and tracking for whether said ordered goods or services have been delivered;
perform an operation of settling accounts for said purchase transactions according to authenticated accounts;
perform the operations of tracking the status of delivering said ordered services or goods and taking down suppliers providing systems for delivering said ordered services or goods; and
perform operations of receiving responses from said customer and redirecting said responses to relative enterprises.

18. The server system according to claim 16, said processor operating said program codes for managing said stocks to
perform operations of accessing and displaying goods or service categories and manipulating modifications to said goods or service categories;
perform operations of modifying an amount when goods being laid in stocks of said electrical stores and notifying how many reserves in said stocks;
perform operations of modifying an amount when goods being taken out from stocks of said electrical stores and notifying how many reserves in said stocks; and
perform operations of managing information concerned with suppliers who cooperates with said mart union.

19. The server system according to claim 16, said processor operating said program codes for managing said sales flow to
manage an urgent selling; and
perform an operation of assigning a procedure for said purchase transaction of said electrical stores.

20. The server system according to claim 16, said processor operating said program codes for managing said payment services to
receive an amount of money concerned with said purchase transaction;
receive an authenticated account of said customer; and
settle account for said purchase transaction by using said authenticated account and said amount of money.
